(19) United States
(12) Patent Application Publication
(10) Pub. No.: US 2016/0039241 A1
(43) Pub. Date: Feb. 11, 2016

(54) SECURITY DOCUMENT AND A METHOD OF DETECTING THE EDGE OF A SECURITY DOCUMENT

(71) Applicant: INNOVIA SECURITY PTY LTD, Craigieburn, Victoria (AU)

(72) Inventors: Michael HARDWICK, Wandong, VIC (AU); Gary Fairless POWER, Greenvale, VIC (AU)

(73) Assignee: Innovia Security Pty Ltd, Craigieburn, VIC (AU)

(21) Appl. No.: 14/781,488

(22) PCT Filed: Mar. 28, 2014
(86) PCT No.: PCT/AU2014/000331

§ 371 Date: Sep. 30, 2015

(30) Foreign Application Priority Data
Apr. 3, 2013 (AU) 2013901143
Apr. 12, 2013 (AU) 2013100406

(51) Int. Cl. B42D 25/328; B42D 25/351; B42D 25/29

(52) U.S. Cl. CPC B42D 25/328; B42D 25/29; B42D 25/351

(57) ABSTRACT

A security document is formed from a transparent plastics substrate having opacifying layers applied to its front and rear surfaces except in at least one window region. A diffractive device provided in the window region, the diffractive device operating in the near infrared (NIR) region of the electromagnetic spectrum, whereby when the security document is passed through an edge detection apparatus that operates in the near infrared (NIR) region, the diffractive device diverts a detector beam of edge detection apparatus away from an edge detector used to detect an edge of the security document, thereby avoiding false positive edge detection results.

### FIELD OF THE INVENTION

The invention generally relates to security documents, and more particularly, but not exclusively, to banknotes which are detectable by automatic teller machines (ATMs), and similar devices.

Security Document or Token

As used herein, the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied.

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

The use of plastic or polymeric materials in the manufacture of security documents pioneered in Australia has been very successful because polymeric banknotes are more durable than their paper counterparts and can also incorporate new security devices and features. One particularly successful security feature in polymeric banknotes produced for Australia and other countries has been a transparent area or “window”.

Transparent Windows and Half Windows

As used herein, the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, sometimes referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrate to be formed from an substantially opaque material, such as paper or fibrous material, with an insert of transparent plastics material inserted into a cut-out, or recess in the paper or fibrous substrate to form a transparent window or a translucent half-window area.

The term “window” used herein encompasses fully transparent windows, translucent windows and “half windows”.

Opacifying Layers

Opacifying layers applied to a transparent substrate may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other substantially opaque material to which indicia may be subsequently printed or otherwise applied.

Security Device or Feature

As used herein, the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document, security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Diffractive Optical Elements (DOEs)

As used herein, the term diffractive optical element refers to a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

### BACKGROUND OF THE INVENTION

Polymeric banknotes incorporating windows or half windows have been successfully produced in Australia and several other countries for a number of years. However, polymeric banknote issuers and designers have imposed several limitations on the size and physical location of windows within the note.

A banknote generally comprises a rectangular flexible sheet having opposed longer side edges and opposed shorter side edges. The sheet has a major central longitudinal axis extending parallel to its longer side edges and a minor central transverse axis extending parallel to its shorter side edges.

Hitherto, banknote designers have restricted the location of windows to certain regions of a banknote for a number of reasons. First, it has previously been believed that for optimum processing, many banknote processing machines require an opaque area at a leading side edge in order that the start of a banknote can be identified and the banknote can then be tracked as it passes through the processing machine.

The leading side edge is usually one or both of the shorter side edges, but it is also possible for a leading side edge to be a longer side edge. Also, the size and location of window areas has been restricted by the belief that certain sensors in banknote processing machines will treat window areas as holes. Further, there is an assumed restriction that windows should not be located on central major and minor axes or even on quarter transverse lines because these commonly serve as fold lines, when banknotes are folded by the general public.

These restrictions discussed above have limited the surface area of the banknote within which windows or half-windows have been located. These restrictions allow less design freedom, and can make the resulting banknotes more vulnerable to the casual counterfeiter than would be the case if the banknote designer could position larger windows or half windows in a wider range of areas of the banknote.

It is therefore desirable to provide the banknote designer with the freedom to position windows or half windows in a wide range of areas of a banknote, and to provide a banknote with at least one window which is more difficult to counterfeit than if the window is restricted to a small size and a small range of locations on the document. Issues associated with banknote detection by ATMs however, have largely remained unresolved.

ATMs, in this respect, incorporate near-infrared (NIR) emitters, such as NIR light-emitting diodes (LED), which operate in conjunction with NIR sensors, such as camera detectors and supporting circuitry and associated software to provide an edge detection apparatus, as banknotes are passed through the ATM.

Some ATMs have had difficulty in processing banknotes with windows, placing restrictions on the size and location of the windows and/or the location of the NIR emitters and sensors of the edge detection apparatus within the ATMs. Further, trials on banknotes with edge-to-edge windows have indicated that ATMs have difficulty processing such banknotes. The ATM detects the banknote as two separate notes, which may consequently lead to the ATM rejecting the banknote and hence has the possibility of rejecting it.

These difficulties are attributable to the inability of the banknote detectors in the ATMs to detect the edge of the banknote without the use of opacifying layers. In fact, the opacification needs to contain at least four layers of opacifying ink in order for the banknotes to be detected by ATMs. A further complicating factor is that different ATM suppliers use different detector configurations. A transmissive or reflective configuration may be used, and manufacturers typically adopt one approach or the other, though one supplier uses both a transmissive and a reflective configuration.

ATM edge detectors generally operate in the near-infrared (NIR) region, approximately between 800 to 950 nm range of wavelengths. Typically, in transmissive configuration, an opacified coating breaks the NIR beam to indicate that there is an edge to the banknote. In reflective configuration, the NIR beam is directed at an angle (typically 45 degrees) to the banknote path, with an NIR detector located on the same side of the banknote. The banknote is arranged to pass over a dark surface which absorbs the NIR before the edge of the banknote reaches the beam. Thus, the edge of the banknote is detected by the NIR detector detecting the NIR beam as it is reflected by the opacifying coating of the banknote.

One proposed approach to this issue has been the use of transparent NIR absorbing coatings. This approach has generally proven unsuccessful, as the level of absorption/refraction required for efficient detection is difficult to reach without use of heavy and/or multiple coatings. The resulting appearance of the window is not sufficiently clear or transparent to provide a pleasing result.

There exists, in view of the foregoing, a need for techniques which allow greater design freedom for banknote design, while also maintaining compatibility with edge detection apparatus used in existing ATMs.

### SUMMARY OF THE INVENTION

The present invention resides in a recognition that diffractive optics of suitable arrangement and construction can be used in association with windows on security documents and, in particular, banknotes for successful edge detection of the banknotes using conventional edge detector apparatus.

More particularly, a diffractive optical device—for example, in the form of a DOE or diffractive lens—can formed in or applied to windows on a security document to re-direct an NIR detector beam away from a detector sensor.

This principle is more broadly applicable to security documents of any kind, and detectors for such security documents, whether deployed in ATMs or elsewhere.

According to one aspect of the invention, there is provided a security document comprising a sheet having a front surface, a rear surface and side edges, the sheet having at least one window region formed therein of a transparent or translucent material, and a diffractive device provided in the window region, the diffractive device operating in the near infrared (NIR) region of the electromagnetic spectrum and being constructed and arranged so that, when the security document is passed through an edge detection apparatus which operates in the near infrared (NIR) region and which has a near infrared (NIR) sensor for detecting an edge of the security document, the diffractive device diverts a near infrared (NIR) detector beam of the edge detection apparatus away from the near infrared (NIR) sensor of the edge detection apparatus.

According to another aspect of the invention, there is provided a method of detecting the edge of a security document comprising a sheet having at least one window region formed from a transparent or translucent material, and a diffractive device provided in the window region, the method comprising:
providing an edge detection device that has a near infrared (NIR) emitter for emitting a near infrared (NIR) detector beam and a near infrared (NIR) sensor for sensing the near infrared (NIR) detector beam,
passing the security document through the edge detection apparatus along a transport path with the near infrared (NIR) emitter disposed on one side of the transport path and the near infrared (NIR) sensor disposed on one side of the transport path,

wherein the diffractive device in the window of the security document is arranged to operate in the near infrared (NIR) region of the electromagnetic spectrum, so that when the security document is passed through the edge detection device along the transport path, the near infrared (NIR) detector beam is diverted away from the near infrared (NIR) sensor whereby the near infrared (NIR) sensor only detects the edges of the security document and does not detect the window in the security document.

Preferably, the diffractive device is a diffractive optical element (DOE) as defined herein, or a diffractive lens. It is, however, possible that other diffractive optical devices, such as holograms, diffractive zone plates or diffusers could be used, provided they are arranged or configured to operate in the near infrared (NIR) region to divert an NIR detector beam.

Banknotes constructed in accordance with embodiments of the invention have the advantage that such banknotes can enjoy greater design freedom—as larger transparent or translucent windows, such as edge to edge windows, can be placed in otherwise prohibited zones of the banknote—while allowing for reliable edge detection of the banknotes in conventional ATMs.

The DOE or other diffractive device may also operate in the visible region of the electromagnetic spectrum to provide a security device which can be used for validation of the security document by providing a visible image when the diffractive device is illuminated by a suitable source of visible light. DOE's are particularly suitable for use in the present invention, since they can be designed to operate within a relatively narrow range of wavelengths. For example, a DOE can be designed to be responsive to a range of wavelengths overlapping the NIR region and the red region of the visible spectrum, so that the DOE is responsive to NIR and red light from a point light source, such as a red LED.

Furthermore, vending machines, which typically use simple banknote validators that do not detect for conventional security features used in banknotes, can be adapted where necessary to validate banknotes provided in accordance with an embodiment of the invention, in which the DOE is provided along an edge of the banknote.

In a particularly preferred embodiment, the window region extends substantially from one side edge to an opposite side edge of the sheet Such a window may be a full edge-to edge window which extends completely between said one side and opposite side edges of the sheet. Alternatively, the window region may terminate shortly before one of both of the side edges. The window region may be interrupted along its length. In one embodiment, in an oblong rectangular sheet the window region is spaced from the shorter end edges of the sheet. Alternatively, the window region may extend along a shorter end edge of the sheet. The window region may have substantially straight borders or may have one or more curved borders. It will, however, be appreciated that windows of a wide variety of sizes and shapes may be provided at different locations on the sheet.

In one embodiment, the diffractive device is applied to at least one surface of the sheet. In another embodiment, the sheet has diffractive devices applied to both the front and rear surfaces of the sheet. In a further embodiment, the diffractive device is integrally formed with a transparent or translucent substrate forming the window region of the security document. In yet another embodiment, the DOE, diffractive lens of other diffractive device may be combined with a transparent near infrared (NIR) absorbing coating.

### DESCRIPTION OF THE DRAWINGS

Embodiments of the invention will now be described with reference to the accompanying drawings. It is to be appreciated that the embodiments are given by way of illustration only.

FIG. 1 is a schematic representation of a prior art arrangement by which an existing ATM having a transmission detector fails to edge detect a banknote having a conventional edge-to-edge window.

FIG. 2 is a schematic arrangement, similar to that of FIG. 1, in which an existing ATM having a transmission detector successfully edge detects a banknote having an edge-to-edge window in accordance with an embodiment of the present invention.

FIG. 3 is a schematic representation, in plan, of the banknote of FIG. 2.

FIG. 4 is a schematic representation, in plan, of a banknote having an window region of a different shape to that depicted in FIG. 3,

FIG. 5 is a schematic representation of a prior art arrangement by which an existing ATM having a reflection detector fails to edge detect a banknote having a conventional edge-to-edge window.

FIG. 6 is a schematic arrangement, similar to that of FIG. 5, in which an existing ATM having a transmission detector successfully edge detects a banknote having an edge-to-edge window in accordance with an embodiment of the present invention.

### DETAILED DESCRIPTION OF PREFERRED EMBODIMENTS

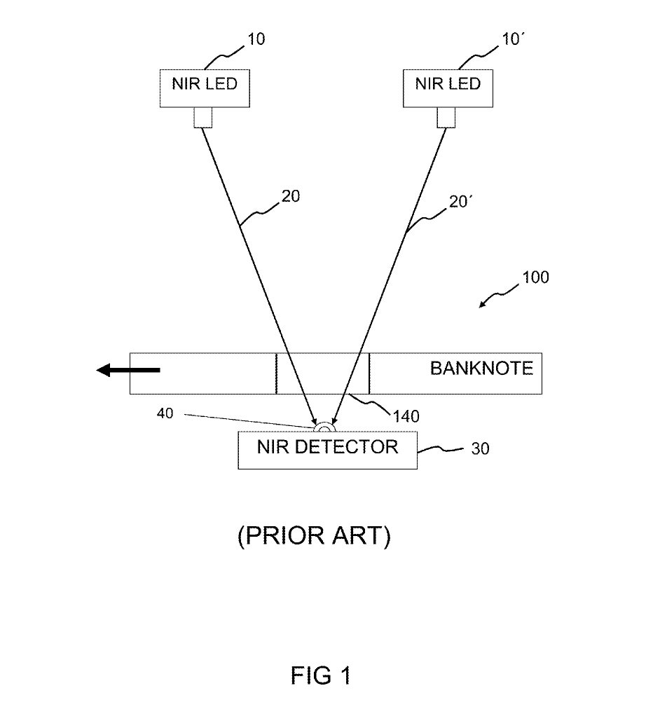

FIG. 1 represents a banknote 100 having a transparent or translucent edge-to-edge window 140, and depicted passing through an ATM. While no technical limitations, per se, constrain manufacture of such banknotes having transparent/translucent windows 140 of the type deployed, they are in practice to be avoided. This is because of problematic issues that arise as a consequence of use of such banknotes 100 with existing ATMs, as referred to above and also described below,

The banknote 100, as described above, passes through an ATM, which has twin light emitting diodes (LEDs) 10, 10′ that provide beams of near infrared (NIR) radiation 20, 20′. The LEDs are arranged in a spaced apart manner on one side of the banknote pathway internal to the ATM. The LEDs 10, 10′ direct their respective beams 20, 20′ across the banknote pathway towards a detector 30 which has a near infrared (NIR) sensor 40.

As the beams 20, 20′ are in the near-infrared (NIR) portion of the electromagnetic spectrum, a number of opacifying layers are required to block the beams 20, 20′ from reception at the detector 30. Use of an edge-to-edge window 150 in the banknote 100 that omits opacifying layers, or has insufficient opacifying layers applied to the polymeric substrate of the banknote 100 to absorb the beams 20, 20′, leads to detection of the beams 20, 20′ at the detector when the edge-to edge window 150 is in the path of the NIR beams 20,20′.

Consequently, the ATM deduces that no banknote is positioned above the detector 30, which as a result causes errors in handling and verification processes in the ATM. Conversely, two banknotes may be detected by the ATM, as two edges are, in effect, presented by the edges of the window 140. As a consequence, constructions having a simple window 140 of this sort are avoided due to such problems, which arise with their use in ATMs using banknote detectors.

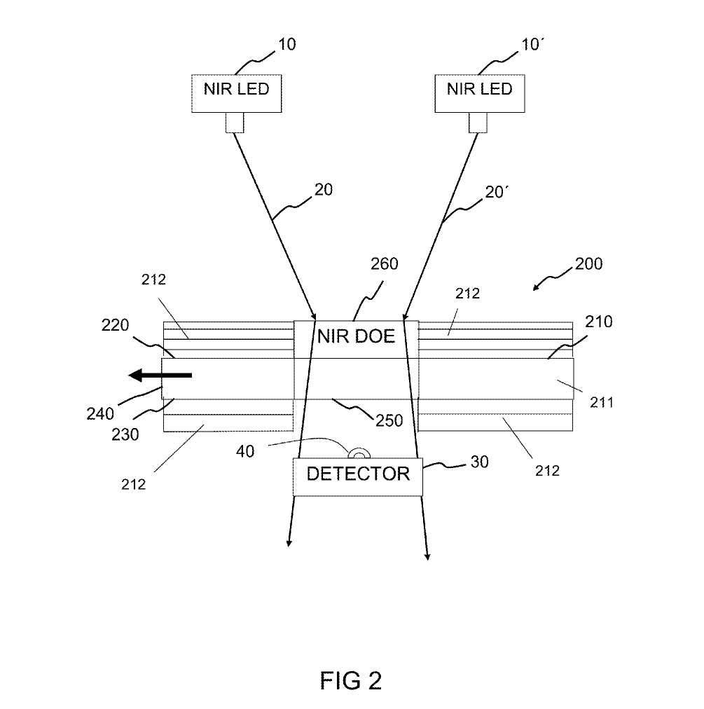

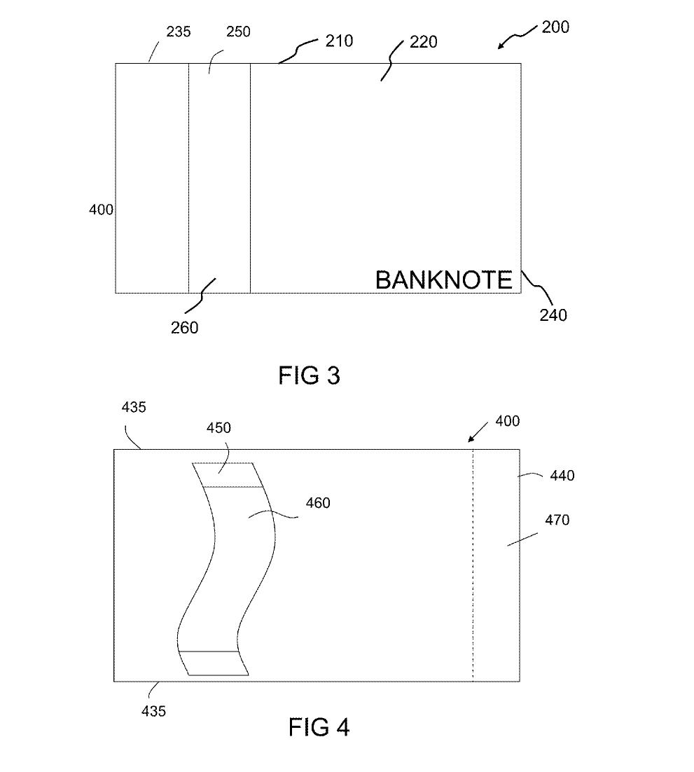

FIGS. 2 and 3 schematically represent a banknote 200 constructed in accordance with an embodiment of the present invention. FIG. 2 shows the banknote 200 passing through a banknote pathway of an ATM having a banknote detector of a construction similar to that depicted in and described with reference to FIG. 1.

The banknote 200 comprises a sheet 210 formed of a transparent polymeric substrate 211 having a front surface 220, a rear surface 230, side edges 235 and end edges 240. A plurality of opacifying layers 212 are applied to each of the front and rear surfaces 220, 230 of the substrate 211 except in at least one window region 250. The window region 250 is transparent or translucent, and extends between the opposing side edges 235 of the banknote 200. In a preferred embodiment, a total of at least four opacifying layers 212 are applied to the substrate so that the areas of the banknote outside the window 250 are effectively opaque to near infrared (NIR) radiation, and at least partially opaque to visible light. Preferably, at least two opacifying layers 212 are applied to each of the upper and lower surfaces 220, 230 of the transparent substrate 211, though the number of opacifying layers on each side may be varied at different locations of the banknote to create half-windows and shadow images.

A diffractive optical device 260 that operates in the near infrared (NIR) region is associated with the window region 250, and may comprise an NIR diffractive optical element (DOE), a diffractive lens or other diffractive device. The NIR DOE or other diffractive optical device 260 may be applied using any suitable technique to the front surface 220 of the substrate, coincident with the window region 250. The NIR DOE 260 preferably at least covers the window region 250, and can alternatively be applied to the rear surface 230 of the banknote 200, rather than the front surface 220. Separate NIR DOEs can be applied to both the front surface 220 and the rear surface 230, if required.

Alternatively, the NIR DOE 260 may in alternative constructions be integral with the window region 250, and—as an example—embossed in the window region 250, or formed by some other such technique.

As depicted in FIG. 2, the banknote 200 has an NIR DOE 260 applied to and overlaying the entire width of the window region 250.

As the banknote 200 is passed through an ATM, the DOE 260 diverts NIR detector beams 20, 20′ within the ATM away from the sensor 40 of the NIR detector, thereby ensuring that false edges are not recorded by the detector 30, which is arranged for edge detection of the banknote 200.

FIG. 3 depicts the banknote 200 of FIG. 2 in plan view.

FIG. 4 depicts an alternative embodiment of a banknote 400 showing different modifications to the window size and locations. The banknote 400 has a window 450 which in which the window region of an irregular shape, rather than a regular rectangular shape as depicted in FIG. 3. The window 450 extends substantially between the longer opposite side edges 435 of the banknote, but terminates just short of the edges 435. Another modification is shown in FIG. 4 in that the DOE 460 extends across the whole width of the window and covers a large area of the window, but does not cover the entire length of the window 450. In a further modification, the banknote may be provided with an edge window 470 along a shorter end edge 440, as shown in broken lines, and which extends substantially between the longer side edges 435.

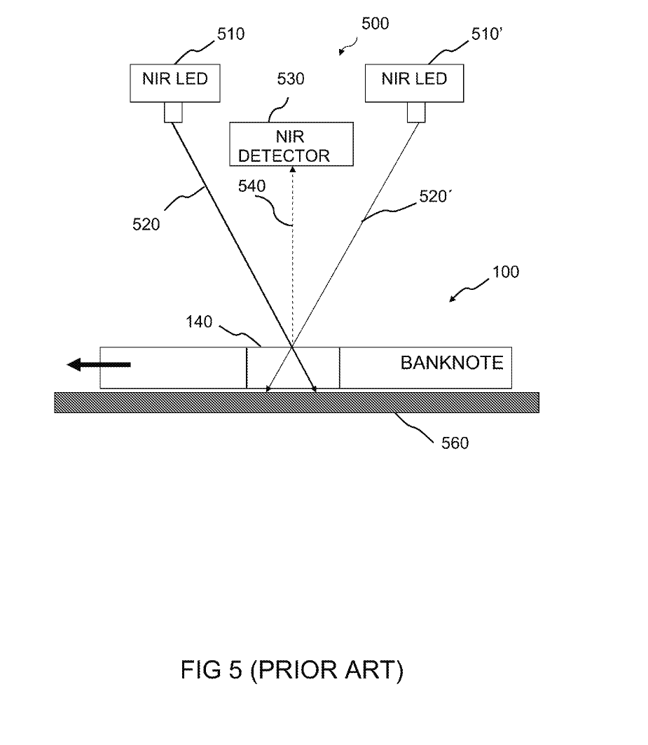

FIG. 5 represents a banknote 100 having a transparent or translucent edge-to-edge window 140, and depicted passing through an ATM with edge detecting apparatus 500 which operates in reflection.

The edge detecting apparatus 500 is similar to that of FIG. 1 in that it has a pair of light emitting diodes (LEDs) 510, 510′ which provide beams 520, 520′ of near infrared (NIR) radiation, and a detector 530 which has a near infrared sensor. However, in contrast to FIG. 1, the NIR detector 530 is located on the same side of the banknote path as the NIR LEDs 510, 510′, so that the detector 530 can detect a reflected beam of NIR 540 reflected back from the surface of the banknote 100. FIG. 5 also differs from FIG. 1 in a dark NIR absorbing surface 560 is disposed on the opposite side of the banknote path to the NIR LEDs 510, 510′ and the NIR detector 530. Thus when no banknote is present in the ATM, the NIR beams 520, 520′ are absorbed by the dark surface 560, and are not reflected back to the NIR detector 530.

When the transparent or translucent edge-to-edge window 140 of the banknote moves into the path of the NIR beams 520, 520′, rather than being reflected back to the NIR detector 530, the NIR beams pass through the edge-to edge window 140, which is substantially transparent to NIR radiation, instead of being reflected back to the NIR detector 530.

Consequently, the ATM deduces that no banknote is positioned below the detector 530, which as a result causes errors in handling and verification processes in the ATM. Conversely, two banknotes may be detected by the ATM, as two edges are, in effect, presented by the edges of the window 140. As a consequence, constructions having a simple edge-to-edge window 140 of this sort are avoided due to such problems, which arise with their use in ATMs using NIR banknote detectors.

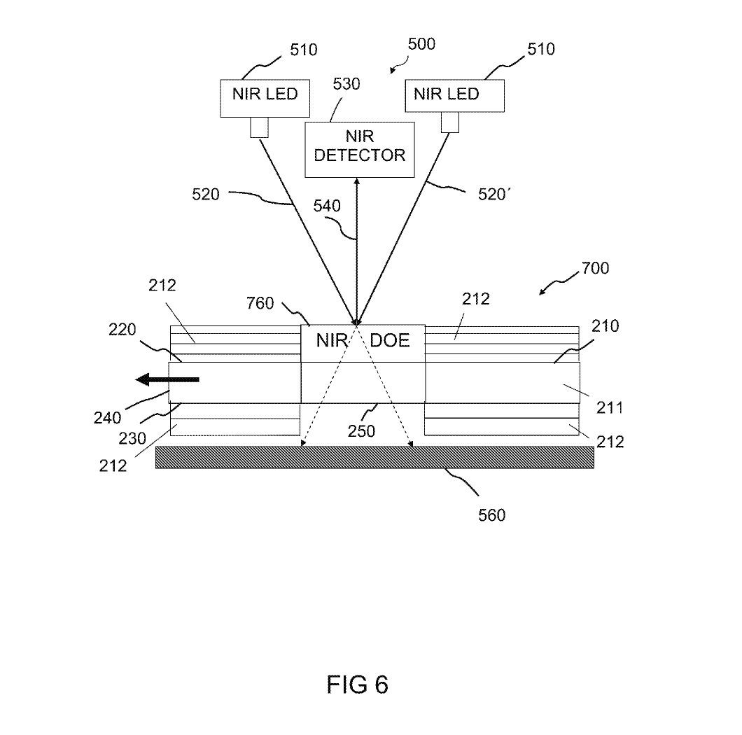

FIG. 6 shows a banknote 700 similar to that of FIGS. 2 and 3 passing through a banknote pathway of an ATM having a banknote detector 500 of a construction similar to that depicted in and described with reference to FIG. 5. The banknote 700 is similar to that of FIGS. 2 and 3 and corresponding reference numerals have been applied to corresponding parts.

The banknote 700 in FIG. 6, differs from the banknote 200 of FIG. 2 in that it has a reflective NIR DOE 760 applied to and overlaying the entire width of the window region 250, instead of a transmissive DOE.

As the banknote 200 is passed through an ATM, the DOE 760 diverts the NIR detector beams 520, 520′ within the ATM by reflecting the beams 520, 520′ towards the NIR detector 530 as shown by reflected beam 540, instead of the beams passing through the window 250 which is substantially transparent to NIR radiation. This ensures that false edges are not recorded by the detector 530 when the window moves into the path of the NIR beams 520, 520′.

To allow a banknote to be compatible with ATM and cash detector machines typically in use (and variously using transmissive and reflective detectors as described above), a combination of the following can be used:
DOE/diffractive optics in combination with a NIR absorbing coating
2 DOEs/Diffractive optics, eg a transmissive DOE and a reflective DOE
1 DOE/Diffractive optic to satisfy both situations, eg a DOE which is partly transmissive and partly reflective.

Those skilled in the art will appreciate that various modifications of the embodiments described herein are possible without departing from the scope of the invention, as defined by the claims.

1. A security document comprising a sheet having a front surface, a rear surface and side edges, the sheet having at least one window region formed therein of a transparent or translucent material, and a diffractive device provided in the window region, the diffractive device operating in the near infrared (NIR) region of the electromagnetic spectrum and being constructed and arranged so that, when the security document is passed through an edge detection apparatus which operates in the near infrared (NIR) region and which has a near infrared (NIR) sensor for detecting an edge of the security document, the diffractive device diverts a near infrared (NIR) detector beam of the edge detection apparatus away from the near infrared (NIR) sensor of the edge detection apparatus.

2. A security document according to claim 1, wherein the diffractive device includes at least one of the following; a diffractive optical element (DOE); a diffractive lens; a diffractive zone plate; a diffuser; and a hologram.

3. A security document according to claim 1 wherein the diffractive device also operates in the visible region of the electromagnetic spectrum.

4. A security document according to claim 1, wherein the window region extends substantially from one side edge to an opposite side edge of the sheet.

5. A security document according to claim 1, wherein the window region terminates shortly before one or both of the side edges of the sheet.

6. A security document according to claim 4, wherein the window region is interrupted along its length.

7. A security document according, claim 1, wherein the window region is an edge window extending along a shorter end edge of the sheet.

8. A security document according to claim 1, wherein the window region has at least one substantially straight border.

9. A security document according to claim 1, wherein the window region has at least one curved border.

10. A security document according to claim 1, wherein the diffractive device is applied to at least one surface of the sheet.

11. A security document according to claim 1, wherein the sheet has diffractive devices applied to both the from and rear surfaces of the sheet.

12. A security document according to claim 1, wherein the diffractive device is integrally formed with a transparent or translucent substrate of the sheet.

13. A security document according to claim 1, wherein the diffractive device is designed to operate in transmission.

14. A security document according to claim 1, wherein the diffractive device is designed to operate in reflection.

15. A security document according to claim 1, wherein the diffractive device is combined with a substantially transparent rear infrared (NIR) absorbing coating.

16. A security document according to claim 1, wherein the security document is a banknote.

17. A method of detecting the edge of a security document comprising a sheet having at least one window region formed from a transparent or translucent material, and a diffractive device provided in the window region, the method comprising:
providing: an edge detection device that has a near infrared (NIR) emitter for emitting a near infrared (NIR) detector beam and a near infrared (NIR) sensor for sensing the near infrared (NIR) detector beam,
passing the security document through the edge detection apparatus along a transport path with the near infrared (NIR) emitter disposed on one side of the transport path and the near infrared (NIR) sensor disposed on one side of the transport path,
wherein the diffractive device in the window of the security document is arranged to operate in the near infrared (NIR) region of the electromagnetic spectrum, so that when the security document is passed through the edge detection device along the transport path, the near infrared (NIR) detector beam is diverted away from the near infrared (NIR) sensor whereby the near infrared (NIR) sensor only detects the edges of the security document and does not detect the window in the security document

18. A method of detecting the edge of a security document according to claim 17 wherein the diffractive device and the edge detection apparatus are designed to operate in transmission.

19. A method of detecting the edge of a security document according to claim 17 wherein the diffractive device and the edge detection apparatus are designed to operate in reflection.
